(19) United States
(12) Patent Application Publication
(10) Pub. No.: US 2008/0181155 A1
(43) Pub. Date: Jul. 31, 2008

(54) APPARATUS FOR AND METHOD OF DETECTING WIRELESS LOCAL AREA NETWORK SIGNALS USING A LOW POWER RECEIVER

(75) Inventors: Itay Sherman, Ra,anana (IL); Avi Baum, Givat Shmuel (IL); Yaniv Tzoreff, Tel Aviv (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/669,315

(22) Filed: Jan. 31, 2007

(51) Int. Cl. G08C 17/00

(52) U.S. Cl. 370/311

(57) ABSTRACT

A novel and useful apparatus for and method of reducing or minimizing the power required to detect WLAN signals. The present invention provides a mechanism of detecting WLAN signals using either a modified receive path or a separate low power receiver co-located with the WLAN radio. A secondary radio (such as a Bluetooth receiver) is used to detect the WLAN signals, rather than the primary WLAN radio, wherein the secondary radio consumes significantly less power than the primary radio. To search for a new packet to receive, the WLAN device de-activates or shuts down most of its RF, MAC and PHY circuitry to a level that permits it to be re-activated (i.e. turned back on) within a certain time. The lower power receiver is then used to detect the WLAN signal. If a WLAN signal is detected, the WLAN radio is notified which causes it to be re-activated within sufficient time to receive the packet header. If the WLAN radio detects a valid WLAN packet, the WLAN radio proceeds to receive the remainder of the packet.

### FIELD OF THE INVENTION

The present invention relates to the field of data communications and more particularly relates to an apparatus for and method of detecting wireless local area network (WLAN) signals using a low power receiver.

### BACKGROUND OF THE INVENTION

A wireless local area network (WLAN) links two or more computers together without using wires. WLAN networks utilize spread-spectrum technology based on radio waves to enable communication between devices in a limited area, also known as the basic service set. This gives users the mobility to move around within a broad coverage area and still be connected to the network.

For the home user, wireless networking has become popular due to the ease of installation and location freedom with the large gain in popularity of laptops. For the business user, public businesses such as coffee shops or malls have begun to offer wireless access to their customers, whereas some are even provided as a free service. In addition, relatively large wireless network projects are being constructed in many major cities.

There are currently there exist several standards for WLANs: 802.11, 802.11a, 802.11b, 802.11g and 802.11n. The 802.11b has a rate of 11 Mbps in the 2.4 GHz band and implements direct sequence spread spectrum (DSSS) modulation. The 802.11a is capable of reaching 54 Mbps in the 5 GHz band. The 802.11g standard also has a rate of 54 Mbps but is compatible with 802.11b. The 802.11a/g implements orthogonal frequency division multiplexing (OFDM) modulation.

A network diagram illustrating an example prior art WLAN network is shown in FIG. 1.

The example network, generally referenced 50, comprises a WLAN access point 60 (AP) coupled to a wired LAN 52 such as an Ethernet network. The WLAN AP in combination with laptop 64, personal digital assistant (PDA) 66 and cellphone 68, form a basic service group (BSS) 62. A server 51, desktop computers 54, router 56 and Internet 58 are connected to the wired LAN 52.

A WLAN state is any component that can connect into a wireless medium in a network. All stations are equipped with wireless network interface cards (NICs) and are either access points or clients. Access points (APs) are base stations for the wireless network. They transmit and receive radio frequencies for wireless enabled devices to communicate with. Wireless clients can be mobile devices such as laptops, personal digital assistants, IP phones or fixed devices such as desktops and workstations that are equipped with a wireless network interface card.

The basic service set (BSS) is defined as the set of all stations that can communicate with each other. There are two types of BSS: (1) independent BSS and (2) infrastructure BSS. Every BSS has an identification (ID) called the BSSID, which is the MAC address of the access point servicing the BSS. An independent basic service set (BSS) is an ad-hoc network that contains no access points, which means the stations within the ad-hoc network cannot connect to any other basic service set.

An infrastructure basic service set (BSS) can communicate with other stations that are not in the same basic service set by communicating through access points. An extended service set (ESS) is a set of connected BSSs. Access points in an ESS are connected by a distribution system. Each ESS has an ID called the SSID which is a 32-byte (maximum) character string. A distribution system connects access points in an extended service set. A distribution system is usually a wired LAN but can also be a wireless LAN.

The types of wireless LANs include peer to peer or ad-hoc wireless LANs. A peer-to-peer (P2P) WLAN enables wireless devices to communicate directly with each other. Wireless devices within range of each other can discover and communicate directly without involving central access points. This method is typically used by two computers so that they can connect to each other to form a network. If a signal strength meter is used in this situation, it may not read the strength accurately and can be misleading, because it registers the strength of the strongest signal, which may be the closest computer.

A block diagram illustrating an example prior art WLAN transceiver in more detail is shown in FIG. 2. The WLAN transceiver, generally referenced 10, comprises antennas 12, 14, RF switch 16, bandpass filter 18, RF front end circuitry 20, bandpass filter 22, I/Q transceiver 24 that performs I and Q modulation and demodulation, I and Q signal analog to digital converters (ADCs) 26, 28, respectively, I and Q signal digital to analog converters (DACs) 30, 32, respectively, baseband processor/MAC 34, EEPROM 36, static RAM 38, FLASH memory 40, host interface (I/F) 42 and power management circuit 44.

The RF front end circuit 20 functions to filter and amplify RF signals and perform RF to IF conversion to generate I and Q data signals for the ADCs 26, 28 and DACs 30, 32. The baseband processor 34 is a part of the PHY that functions to modulate and demodulate I and Q data and carrier sensing, transmission and receiving of frames. The medium access controller (MAC) functions to control the communications (i.e. access) between the host device and applications. The power management circuit 44 is adapted to receive power via a wall adapter, battery and/or power via the host interface 42. The host interface may comprise PCI, CardBus or USB interfaces.

Orthogonal frequency division multiplexing (OFDM) is a well known communications technique that divides a communications channel into a number of equally spaced frequency bands. A subcarrier carrying a portion of the user information is transmitted in each band. Each subcarrier is orthogonal (i.e. independent of each other) with every other subcarrier, differentiating OFDM from commonly used frequency division multiplexing (FDM). OFDM (also known as multitone modulation) is presently used in a number of commercial wired and wireless applications. In wired applications, it is used in digital subscriber line (DSL) systems.

In wireless applications, OFDM is used in television and broadcast radio such as the European digital broadcast television standard as well as in digital radio in North America. OFDM is also used in fixed wireless systems and wireless local-area network (WLAN) products. A system based on OFDM has been developed to deliver mobile broadband data service (WiMAX) at relatively high data rates.

OFDM systems are effectively a combination of modulation and multiple-access schemes that segments a communications channel in such a way that many users can share it. Whereas TDMA segments are divided according to time and CDMA segments are divided according to spreading codes, OFDM segments are divided according to frequency. It is a technique that divides the spectrum into a number of equally spaced tones (or frequencies) and carries a portion of a user's information on each tone. Although OFDM can be viewed as a form of frequency division multiplexing (FDM), it has the property that each tone is orthogonal to each other. FDM typically requires there to be frequency guard bands between the frequencies so that they do not interfere with each other. In contrast, OFDM permits the spectrum of each tone to overlap, but because they are orthogonal, they do not interfere with each other. By allowing the tones to overlap, the overall amount of spectrum required is reduced significantly

OFDM enables user data to be modulated onto the tones. The information is modulated onto a tone by adjusting the phase and/or amplitude of the tone. In the most basic form, a tone may be present or absent to indicate a single bit of information. Normally, however, either phase shift keying (PSK) or quadrature amplitude modulation (QAM) is typically employed. An OFDM system takes a data stream and splits it into N parallel data streams, each at a rate 1/N of the original rate. Each stream is then mapped to a tone at a unique frequency and combined together using the inverse fast Fourier transform (IFFT) to yield the time-domain waveform to be transmitted.

OFDM is a multiple-access technique since an individual tone or groups of tones can be assigned to different users. Multiple users share a given bandwidth, yielding an OFDMA system. Each user is assigned a predetermined number of tones when they have information to send. Alternatively, a user is assigned a variable number of tones based on the amount of information they need to send. The assignments are controlled by the media access control (MAC) layer, which schedules the resource assignments based on user demand.

OFDM can be combined with frequency hopping to create a spread spectrum system, realizing the benefits of frequency diversity and the interference averaging of CDMA. OFDM thus provides the best of the benefits of TDMA in that users are orthogonal to one another, and of CDMA, while avoiding the limitations of each, including the need for TDMA frequency planning and equalization, and multiple access interference in the case of CDMA.

A problem associated with WLAN transceivers, however, is that their power consumption is a limiting factor in their deployment in mobile networks. WLAN transceivers consume relatively large amounts of power for the following reason. Wireless LAN transceivers are designed to serve computers throughout a structure with uninterrupted service using radio frequencies. Due to the wide bandwidth used, the relatively high SNR required to demodulate the higher order WLAN constellations (64 QAM) and the possibility for strong adjacent channel signals, the transceiver has to sample incoming signals at very high frequency (e.g., 4× or higher then actual bandwidth) using high accuracy ADCs and highly linear receiver chains, all of which consume high power.

In the majority of mobile use cases, a large percent of the time, the mobile WLAN device is operating in the ‘idle’ receive mode. In this mode, the WLAN device is searching for and waiting to receive valid packets either from an access point (AP) or other stations (i.e. ad-hoc network). For active voice connections, the WLAN device is in the idle mode approximately 20-90% of the time, approximately 20-50% for standby operation and approximately 90% for scan operations.

Standard WLAN implementations typically suffer from relatively high idle power consumption (over 85% of the power consumed during active reception). This is because for idle mode operation they use the standard radio receive circuit path which has relatively high power consumption associated with it. The majority of the power consumption occurs in the front end circuit, ADC circuits and the high speed digital correlator logic circuits. Thus, considering the above described usage patterns, idle power consumption constitutes the dominant part of the power budget.

It is thus desirable to have a mechanism that is capable of reducing or minimizing the power consumed while WLAN transceiver devices are in the idle mode searching for WLAN signals. In particular, optimization of the power consumption during the idle mode of operation can significantly reduce the overall power consumption of WLAN devices and permit a wider deployment in mobile devices.

### SUMMARY OF THE INVENTION

The present invention is a novel and useful apparatus for and method of reducing or minimizing the power consumed while WLAN transceiver devices are in the idle mode searching for WLAN signals. The present invention provides a mechanism of detecting WLAN signals using a low power receiver. Considering the WLAN transceiver to be the primary radio, the mechanism of the present invention uses a secondary radio to detect the WLAN signals, rather than the primary WLAN radio, wherein the secondary radio consumes significantly less power than the primary radio. The WLAN signal detection mechanism is operative to cut the current consumption associated with searching for a WLAN signal by using a lower power receiver such as a Bluetooth receiver that is co-located with the WLAN transceiver, which is typically the case.

In operation, when the WLAN radio is searching for a new packet to receive, the WLAN device de-activates or shuts down most of its RF, MAC and PHY circuitry to a level that permits it to be re-activated (i.e. turned back on) within a certain time. The lower power receiver is then used to detect the WLAN signal. If a WLAN signal is detected, the WLAN radio is notified which causes it to be re-activated within sufficient time to receive the packet header. If the WLAN radio detects a valid WLAN packet, the WLAN radio proceeds to receive the remainder of the packet.

Although the mechanism of the present invention can be used in numerous types of communication systems wherein the secondary radio may comprise any lower power radio, to aid in illustrating the principles of the present invention, the description of the WLAN signal detection mechanism is provided in the context of a WLAN radio co-located with a Bluetooth radio that is part of a cellular phone.

Although the WLAN signal detection mechanism of the present invention can be incorporated in numerous types of communication devices such a multimedia player, cellular phone, PDA, etc., it is described in the context of a cellular phone. It is appreciated, however, that the invention is not limited to the example applications presented, whereas one skilled in the art can apply the principles of the invention to other communication systems as well without departing from the scope of the invention.

The WLAN signal detection mechanism has several advantages including the following: (1) use of a low power receiver can reduce power consumption during the WLAN idle mode of operation by 80% which translates to over 40% of power savings for common usage scenarios of active call, standby and scan; (2) the reuse of the Bluetooth or other low power receiver resources for co-located or integrated designs or reuse of the standard WLAN receiver infrastructure minimizes the added cost of implementing the mechanism of the present invention; (3) the mechanism does not require modifications to WLAN standard protocols or peer devices thus permitting operating with any WLAN equipped devices deployed currently or in the future; (4) implementing the invention does not require additional hardware nor complex and expensive filters; and (5) the mechanism does not require any modifications to cellular modem hardware or software.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

There is thus provided in accordance with the present invention, a method of detecting wireless local area network (WLAN) transmission signals for use in communication systems incorporating a WLAN radio and a secondary lower power receiver, the method comprising the steps of de-activating the WLAN radio, activating and tuning the secondary receiver to a WLAN transmit frequency, detecting received signal energy at the WLAN transmit frequency on the secondary receiver, activating the WLAN radio and receiving a WLAN packet header in response to detecting signal energy at the WLAN transmit frequency over the secondary receiver and receiving the remainder of the packet over the WLAN radio if a valid WLAN signal is detected.

There is also provided in accordance with the present invention, a method of detecting wireless local area network (WLAN) transmission signals for use in communication systems incorporating a WLAN radio and a secondary receiver, the method comprising the steps of utilizing the secondary receiver as a WLAN preamble detector wherein the secondary receiver is configured to detect WLAN transmit energy and activating the WLAN radio if a WLAN signal is detected.

There is further provided in accordance with the present invention, an apparatus for detecting wireless local area network (WLAN) transmission signals comprising a WLAN radio, a secondary receiver, signal detection means coupled to the WLAN radio and the secondary receiver, the signal detection means operative to utilize the secondary receiver as a WLAN preamble detector wherein the secondary receiver is configured to detect WLAN transmit energy and activate the WLAN radio and switch reception to the WLAN radio if signals received by the secondary receiver indicate reception of a suspected WLAN packet.

There is also provided in accordance with the present invention, a mobile communications device comprising a cellular radio, a WLAN radio, a secondary receiver, a processor coupled to the WLAN radio, the secondary receiver and the cellular radio, the processor operative to utilize the secondary receiver as a WLAN preamble detector wherein the secondary receiver is configured to detect WLAN transmit energy and activate the WLAN radio and switch reception to the WLAN radio if signals received by the secondary receiver indicate reception of a suspected WLAN packet.

### BRIEF DESCRIPTION OF THE DRAWINGS

The invention is herein described, by way of example only, with reference to the accompanying drawings, wherein:

FIG. 1 is a network diagram illustrating an example prior art WLAN network;

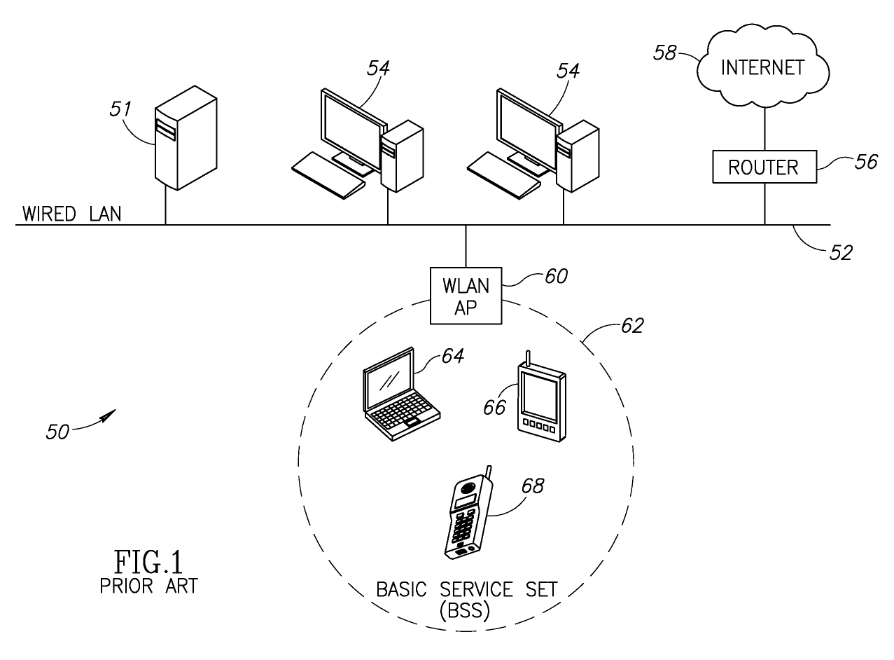

FIG. 2 is a block diagram illustrating an example prior art WLAN transceiver in more detail;

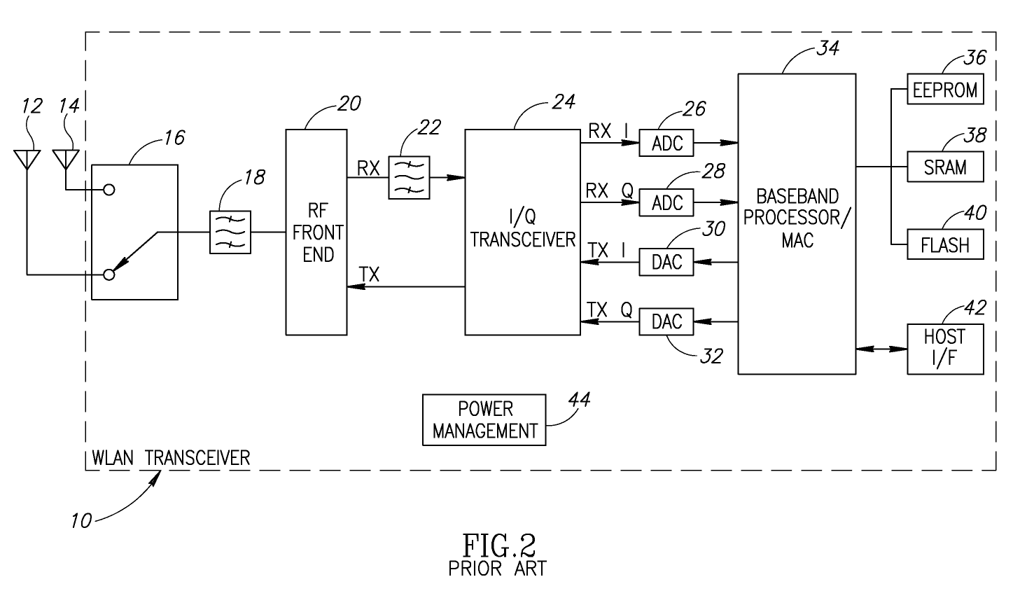

FIG. 3 is a block diagram illustrating an example communication device in more detail incorporating the WLAN signal detection mechanism of the present invention;

FIG. 4 is a simplified block diagram illustrating the WLAN signal detection mechanism of the present invention;

FIG. 5 is a flow diagram illustrating the WLAN signal detection method of the present invention;

FIG. 6 is a flow diagram illustrating a first alternative detection method of the present invention;

FIG. 7 is a flow diagram illustrating a second alternative detection method of the present invention; and

FIG. 8 is a diagram illustrating the frequency sample points for the first alternative detection method of FIG. 6.

### DETAILED DESCRIPTION OF THE INVENTION

### Notation Used Throughout

The following notation is used throughout this document.

| Term | Definition |
|---|---|
| AC | Alternating Current |
| ACE | Active Constellation Extension |
| ADC | Analog to Digital Converter |
| AP | Access Point |
| ASIC | Application Specific Integrated Circuit |
| AVI | Audio Video Interleave |
| BMP | Windows Bitmap |
| BSS | Basic Service Set |
| CDMA | Code Division Multiple Access |
| CPU | Central Processing Unit |
| DAC | Digital to Analog Converter |
| DC | Direct Current |
| DSL | Digital Subscriber Loop |
| DSP | Digital Signal Processor |
| DSSS | Direct Sequence Spread Spectrum |
| DTV | Digital Television |
| EPROM | Erasable Programmable Read Only Memory |
| ESS | Extended Service Set |
| FDM | Frequency Division Multiplexing |
| FFT | Fast Frequency Transform |
| FM | Frequency Modulation |
| FPGA | Field Programmable Gate Array |
| GPS | Ground Positioning Satellite |
| HDL | Hardware Description Language |
| I/F | Interface |
| ICI | Intercarrier Interference |
| ID | Identification |
| IEEE | Institute of Electrical and Electronics Engineers |
| IFFT | Inverse Fast Frequency Transform |
| IP | Internet Protocol |
| JPG | Joint Photographic Experts Group |
| LAN | Local Area Network |
| MAC | Media Access Control |
| MP3 | MPEG-1 Audio Layer 3 |
| MPG | Moving Picture Experts Group |
| NIC | Network Interface Card |
| OFDM | Orthogonal Frequency Division Multiplexing |
| P2P | Peer to Peer |
| PAPR | Peak to Average Power Ratio |
| PC | Personal Computer |
| PCI | Personal Computer Interconnect |
| PDA | Portable Digital Assistant |
| PSK | Phase Shift Keying |
| QAM | Quadrature Amplitude Modulation |
| RAM | Random Access Memory |
| RF | Radio Frequency |
| ROM | Read Only Memory |
| RSSI | Received Signal Strength Indicator |
| SIM | Subscriber Identity Module |
| SNR | Signal to Noise Ratio |
| SSID | Service Set Identifier |
| STA | Station |
| TDMA | Time Division Multiple Access |
| TV | Television |
| USB | Universal Serial Bus |
| UWB | Ultra Wideband |
| WiFi | Wireless Fidelity |
| WiMAX | Worldwide Interoperability for Microwave Access |
| WiMedia | Radio platform for UWB |
| WLAN | Wireless Local Area Network |
| WMA | Windows Media Audio |
| WMV | Windows Media Video |

### DETAILED DESCRIPTION OF THE INVENTION

The present invention is a novel and useful apparatus for and method of reducing or minimizing the power consumed while WLAN transceiver devices are in the idle mode searching for WLAN signals. The present invention provides a mechanism of detecting WLAN signals using a low power receiver. Considering the WLAN transceiver to be the primary radio, the mechanism of the present invention uses a secondary radio to detect the WLAN signals, rather than the primary WLAN radio, wherein the secondary radio consumes significantly less power than the primary radio. The WLAN signal detection mechanism is operative to cut the current consumption associated with searching for a WLAN signal by using a lower power receiver such as a Bluetooth receiver that is co-located with the WLAN transceiver, which is typically the case.

Although the mechanism of the present invention can be used in numerous types of communication systems wherein the secondary radio may comprise any lower power radio, to aid in illustrating the principles of the present invention, the description of the WLAN signal detection mechanism is provided in the context of a WLAN radio co-located with a Bluetooth radio that is part of a cellular phone.

Although the WLAN signal detection mechanism of the present invention can be incorporated in numerous types of communication devices such a multimedia player, cellular phone, PDA, etc., it is described in the context of a cellular phone. It is appreciated, however, that the invention is not limited to the example applications presented, whereas one skilled in the art can apply the principles of the invention to other communication systems as well without departing from the scope of the invention.

Note that throughout this document, the term communications device is defined as any apparatus or mechanism adapted to transmit, receive or transmit and receive data through a medium. The term communications transceiver or communications device is defined as any apparatus or mechanism adapted to transmit and receive data through a medium. The communications device or communications transceiver may be adapted to communicate over any suitable medium, including wireless or wired media. Examples of wireless media include RF, infrared, optical, microwave, UWB, Bluetooth, WiMax, WiMedia, WiFi, or any other broadband medium, etc. Examples of wired media include twisted pair, coaxial, optical fiber, any wired interface (e.g., USB, Firewire, Ethernet, etc.). The term Ethernet network is defined as a network compatible with any of the IEEE 802.3 Ethernet standards, including but not limited to 10Base-T, 100Base-T or 1000Base-T over shielded or unshielded twisted pair wiring. The terms communications channel, link and cable are used interchangeably.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means. Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Mobile Device/Cellular Phone/PDA System

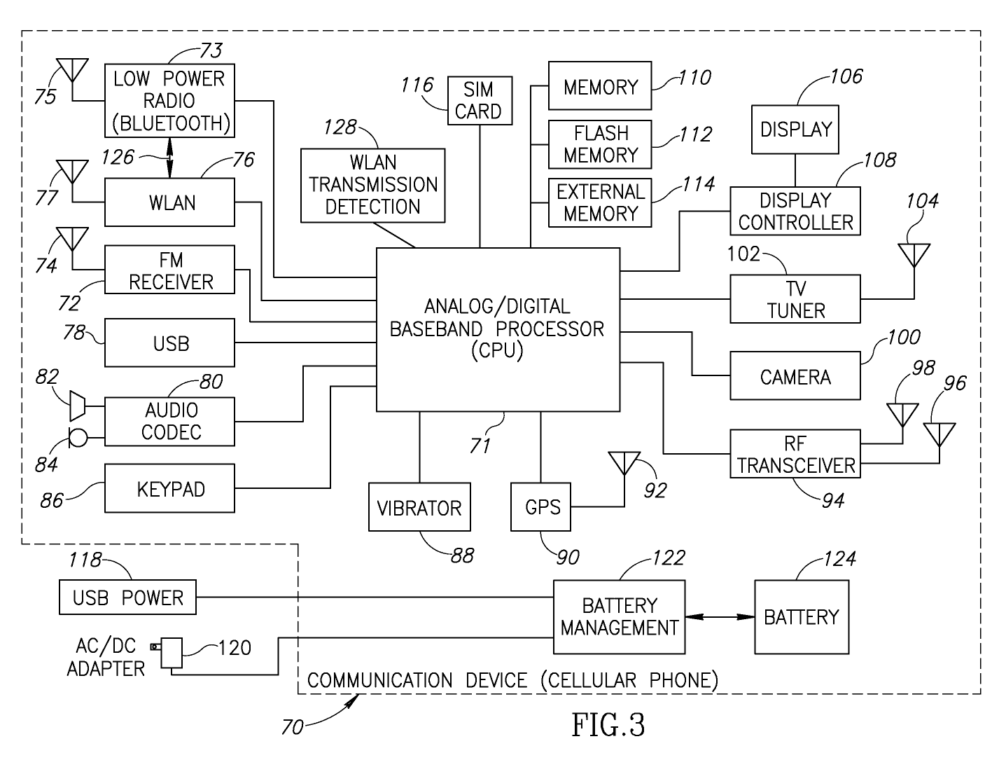

A block diagram illustrating an example communication device in more detail incorporating the WLAN signal detection mechanism of the present invention is shown in FIG. 3. The communication device may comprise any suitable wired or wireless device such as multimedia player, mobile device, cellular phone, PDA, Bluetooth device, etc. For illustration purposes only, the communication device is shown as a cellular phone. Note that this example is not intended to limit the scope of the invention as the WLAN signal detection mechanism of the present invention can be implemented in a wide variety of communication devices.

The cellular phone, generally referenced 70, comprises a baseband processor or CPU 71 having analog and digital portions. The basic cellular link is provided by the RF transceiver 94 and related one or more antennas 96, 98. A plurality of antennas is used to provide antenna diversity which yields improved radio performance. The cell phone also comprises internal RAM and ROM memory 110, Flash memory 112 and external memory 114.

Several user interface devices include microphone 84, speaker 82 and associated audio codec 80, a keypad for entering dialing digits 86, vibrator 88 for alerting a user, camera and related circuitry 100, a TV tuner 102 and associated antenna 104, display 106 and associated display controller 108 and GPS receiver and associated antenna 92.

A USB interface connection 78 provides a serial link to a user's PC or other device. An FM receiver 72 and antenna 74 provide the user the ability to listen to FM broadcasts. WLAN radio and interface 76 and antenna 77 provide wireless connectivity when in a hot spot or within the range of an ad hoc, infrastructure or mesh based wireless LAN network. A low power radio (such as Bluetooth radio) and interface 73 and antenna 75 provide Bluetooth wireless connectivity when within the range of a Bluetooth wireless network. A key characteristic of the Bluetooth or other low power radio is that the power consumed by the receiver is lower than that of the WLAN radio when in the idle mode of operation. Alternatively, the communication device 70 may comprise an Ultra Wideband (UWB) radio and/or WiMAX radio and respective interfaces (not shown). SIM card 116 provides the interface to a user's SIM card for storing user data such as address book entries, etc.

The cellular phone also comprises a WLAN transmission detection block 128 adapted to implement the WLAN signal detection mechanism of the present invention as described in more detail infra. In operation, the WLAN signal detection block 128 may be implemented as hardware, software executed as a task on the baseband processor 71 or a combination of hardware and software. Implemented as a software task, the program code operative to implement the WLAN signal detection mechanism of the present invention is stored in one or more memories 110, 112 or 114.

Portable power is provided by the battery 124 coupled to battery management circuitry 122. External power is provided via USB power 118 or an AC/DC adapter 120 connected to the battery management circuitry which is operative to manage the charging and discharging of the battery 124.

### WLAN Signal Detection

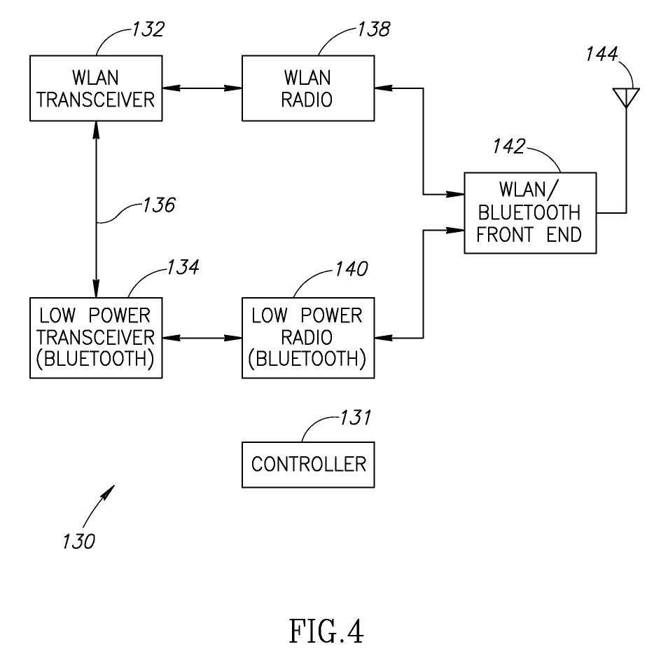

A simplified block diagram illustrating the WLAN signal detection mechanism of the present invention is shown in FIG. 4. The example circuit, generally referenced 130, comprises a WLAN transceiver 132, WLAN radio 138, low power transceiver 134, low power radio 140, Bluetooth WLAN/Bluetooth front end circuit 142, controller 131 and antenna 144. In accordance with the invention, the low power radio and receiver (Bluetooth in this example) is characterized in that it consumes less power than the WLAN receiver. Thus, the low power receiver is used to detect the WLAN signal rather than the WLAN receiver.

The invention contemplates two approaches: (1) using a separate receiver to detect WLAN signals or (2) using the same receiver but a different receive path to detect WLAN signals. In the case of a separate receiver, a different separate receiver such as a co-located Bluetooth receiver is used.

Alternatively, a modified receive path is used for the initial WLAN transmission detection rather than a separate receive path. In this scheme, a different mode of operation is deployed for the standard WLAN receiver. The receiver linearity and bandwidth are dramatically reduced compared to the standard WLAN receiver thereby significantly reducing the current consumption. For example, some or all of the following techniques are used to reduce the power consumption: (1) lower the number of ADC bits; (2) lower the sampling rate; and (3) lower the linearity and LNA current.

In the implementation of either scheme, the receiver performs energy detection and in an alternatively embodiment also performs envelope matching/correlation to detect the WLAN signal. The receiver is tuned so as to provide a minimal number of misdetections (i.e. false negatives) at the expense of a higher number of false detections (i.e. false positives). This is achieved by setting the detection threshold to a low enough level compared to standard operation.

The receiver is operative to detect the signal onset within X microseconds. If a signal is detected, the standard full accuracy receive path is then activated. The standard receiver will then either complete the reception of the packet or reject the packet as a misdetection. Note that the value of X is typically determined by the type of packet preamble the receiver is attempting to detect. For example, the value of X is approximately 3 microseconds for OFDM packets while it is greater than 30 microseconds for Barker/Complementary Code Keying (CCK) packets.

The type of packet to be detected is determined by several factors, including the operating frequency band, the type of network and the particular scenario. Normally, this information is known prior to reception and thus, the receiver is tuned and configured to receive (i.e. detect) a specific type of preamble.

The Barker/CCK preamble is used for (1) active calls on 802.11b or mixed mode 802.11g networks; (2) standby operation on 802.11b and 802.11g networks (Beacons); and (3) scan operation on 802.11b and 802.11g networks. OFDM preamble detection is used for (1) 802.11a operation and (2) active calls on a pure 802.11g network.

Note that a key assumption of the invention is that the power consumption of the secondary receiver is significantly lower than the WLAN receiver. The low power receiver generates an indication (either hardware or software) and signals to the WLAN receiver that a suspected WLAN packet is being received. The WLAN receiver hardware or software/firmware responds to the indication from the low power receiver and reactivates its receiver chain. If a valid packet is detected within the header interval, then the WLAN receiver continues to process the packet. If it did not receive such a packet, it returns to the low power idle mode and waits for an indication (i.e. trigger) from the low power receiver.

Given that the low power detection time is limited to Y microseconds, the sum X+Y should preferably be in the order of 40 microseconds for 802.11b PBCC/CCK/Barker packet detection and less than 4 microseconds for PFDM packet detection. The low power receiver detection is set to minimize misdetection (i.e. false negatives) while allowing some level of false detection (i.e. false positives). This is achieved by setting a low enough energy threshold (or relatively low correlation factor). These false detections are later filtered our by the WLAN receiver.

If X+Y are longer than the OFDM threshold but shorter than the 802.11b threshold, then the WLAN device uses the low power detection mode only in the following conditions: (1) when waiting for a beacon on the 2.4 GHz network; and (2) when waiting for packet reception on 802.11b or 802.11g networks operating in mixed mode and with CTS protection activated. In the case where a single antenna scheme is used in the communication device, a Bluetooth receiver is suitable for use as the low power receiver since during the time period where the WLAN is operating, the Bluetooth receiver is blocked from operating due to the switched signal antenna scheme.

Note that since OFDM packet detection has a limited time available for detection, the mechanism of the invention utilizes energy detection thus making it less optimal for low SNR signals. Preferably, for OFDM signal detection, the operation of the low power detection receiver is limited to certain SNR/RSSI scenarios, for example, setting the threshold for using the low power detection to signals above −70 dbm and with SNR higher then 10 db. The limitation is made by setting the power level for detection to values considerably higher then the normal sensitivity level.

When a station (STA) is connected to an access point (AP), it is operative to estimate the link SNR/RSSI based on incoming traffic and, in turn, activates the low power receiver accordingly. For scan operation, an attempt to perform a scan with the low power receiver activated is made. The low power receiver is turned off and the WLAN receiver activated to search for lower power APs only in the event the low power receiver fails to detect connection candidates.

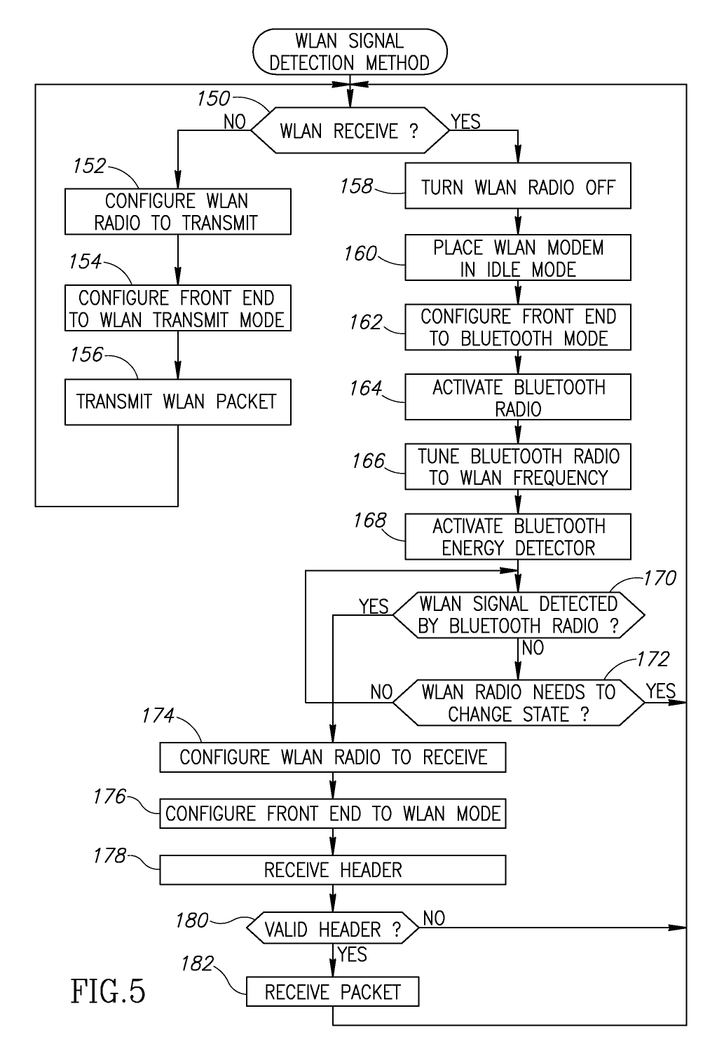

The following methods can be adapted to be executed in software/firmware by the controller 131 (FIG. 4) or in hardware or a combination thereof. A flow diagram illustrating the WLAN signal detection method of the present invention is shown in FIG. 5. With reference to FIGS. 3, 4 and 5, it is first determined if the WLAN radio is to transmit or receive (step 150). If the WLAN radio is to transmit, the controller or other entity configures the WLAN radio to transmit operation (step 152). The front end circuit 142 is configured to WLAN transmit mode operation (step 154) and, once configured, the WLAN packet is transmitted using the WAN radio (step 156).

If the WLAN is to receive (step 150), in accordance with the invention, the WLAN radio is deactivated (i.e. turned off) (step 158). The WLAN radio is placed in the idle mode (step 160), the front end 142 is configured for low power receiver operation (i.e. Bluetooth mode operation in this example) (step 162) and the Bluetooth radio (i.e. the receiver portion) is activated (step 164). The Bluetooth radio is tuned to the particular WLAN frequency (step 166) and the Bluetooth energy detector is activated (step 168). Note that the Bluetooth radio is tuned to one of 14 WLAN channels (11 in the United States).

The Bluetooth radio listens and attempts to detect a WLAN signal by measured the received signal energy within the WLAN channel frequency band. If no signal is detected (step 170), it is checked whether the WLAN radio needs to change state (i.e. a packet is queued to be transmitted) (step 172) and if so, the method returns to step 150. If not, the method continues to check for WLAN signal energy (step 170). Note that two alternative detection methods are described in more detail infra.

If WLAN signal energy is detected (step 170), the WLAN radio is configured to receive mode operation (step 174), the front end is configured to WLAN mode (step 176) and the WLAN radio receives attempts to receive the packet header as normal (step 178). If the received signal is a valid packet header (step 180), the WLAN radio receives the remainder of the packet (step 182), otherwise the method returns to step 150.

### First Alternative WLAN Signal Detection Method—Frequency Envelope Detection

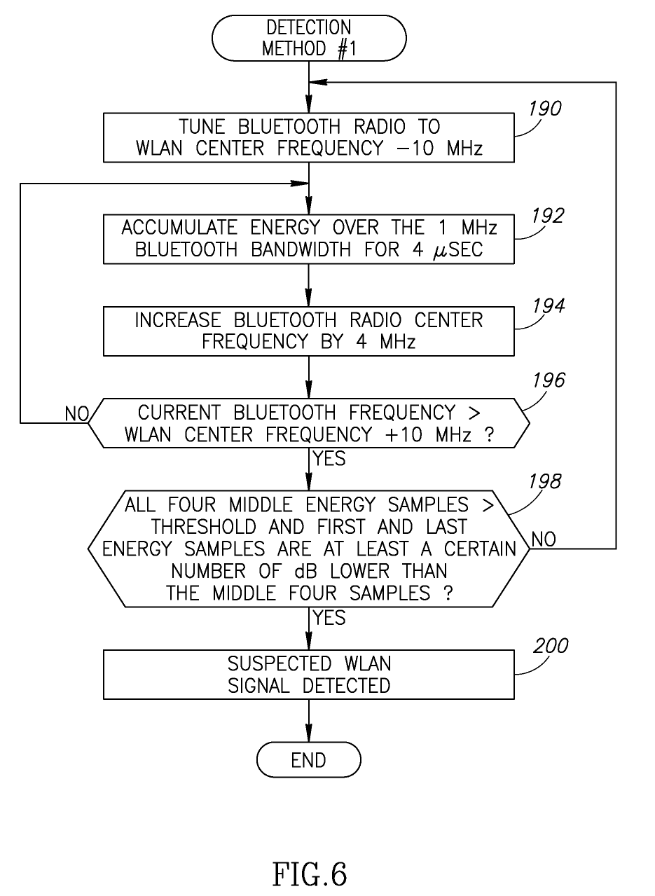

A flow diagram illustrating a first alternative detection method of the present invention suitable for use in the case of a long WLAN preamble is shown in FIG. 6. This method is performed by the detection step 170 of FIG. 5. In general, the method uses the Bluetooth receiver to scan the WLAN channel 20 MHz frequency band searching for a frequency envelope that matches that of the expected WLAN signal.

First, the Bluetooth radio is tuned to 10 MHz below the center frequency of the particular WLAN channel in use (step 190). The receiver (or processor, controller or other processing entity) then accumulates the received signal energy over the 1 MHz Bluetooth bandwidth for a period of time (e.g., 4 microseconds) (step 192). The total energy received is recorded or stored for comparison purposes.

The Bluetooth radio center frequency is increased by a frequency step size (e.g., 4 MHz) (step 194). If the current Bluetooth frequency is not greater than the WLAN center frequency plus 10 MHz (step 196) then the method continues with step 192 wherein the next frequency sample point is taken. Once all the energy sample points have been taken, it is checked whether the four middle energy sample points (out of six total) each exceed a predetermined threshold and whether the first and last energy sample points are at least a certain number of dB lower than the middle four energy sample points (step 198). If both these conditions are true, than it is reported that a suspected WLAN signal is detected (step 200). Otherwise, the method continues to search the WLAN channel frequency band at the beginning (step 190).

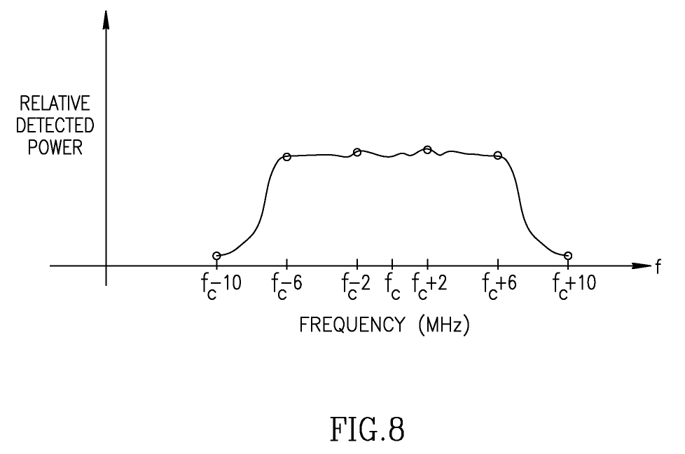

Note that the sample points obtained after execution of the first alternative detection method of FIG. 6 is shown in FIG. 8. The frequencies for the middle six sample points (i.e. two out of the band and four within the band) are chosen to maximize the probability of detecting the WLAN signal. It is appreciated that more or fewer than these six sample points may be taken without departing from the scope of the invention. Further, the acquisition time may be increased or decreased from the example 4 microseconds described herein, depending on the particular implementation of the invention.

### Second Alternative WLAN Signal Detection Method—Single Sample Point

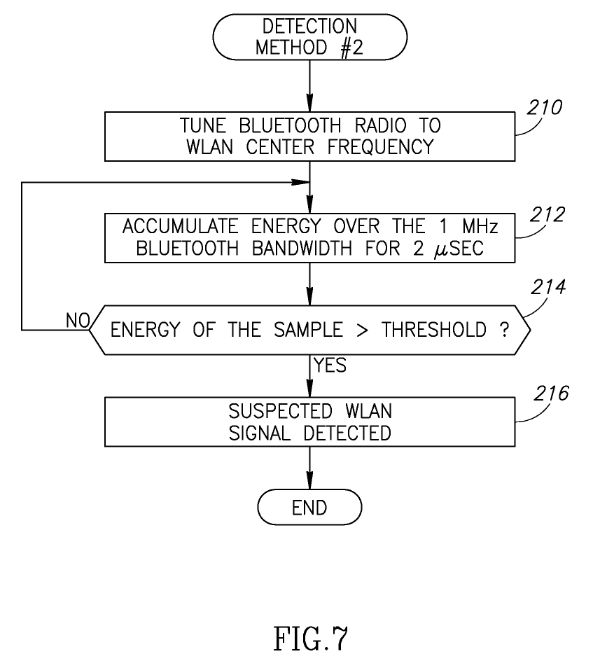

A flow diagram illustrating a second alternative detection method of the present invention is shown in FIG. 7. This method is suitable for cases where the WLAN radio transmission comprise OFDM modulation which have much shorter detection times and shorter preambles. In this case, there is insufficient time to accumulate signal energy over a plurality of sample points thereby detecting the frequency envelope of the WLAN signal. Rather, in this second alternative method, the method accumulates energy at a single point (i.e. the center frequency of the WLAN channel) and this energy is compared to a threshold.

First, the Bluetooth radio is tuned to the center frequency of the particular WLAN channel (step 210). The method then accumulates the received signal energy over a 1 MHz Bluetooth bandwidth for two microseconds (step 212). If the energy of the sample is greater than a threshold (step 214), an indication is generated that a suspected WLAN signal has been detected (step 216). Otherwise, the method returns to step 212 wherein the method continues to search for WLAN signal energy at the WLAN center frequency.

It is noted that this second alternative detection method has a higher false alarm rate then that of the first alternative detection method due to the shortened time to accumulate energy and due to the reduced number of sample points used to make a determination whether a suspected WLAN signal is being received.

In both methods, once a suspected WLAN signal is detected, the low power receiver (i.e.

Bluetooth receiver) is deactivated and the WLAN radio is activated whereby the WLAN radio attempts to receive the signal and check for a valid WLAN packet header. If a valid packet header is received, the WLAN radio receives the remainder of the packet. If a valid packet header is not found (misdetection), the WLAN radio is deactivated and the low power receiver continues to be used to detect a WLAN signal.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of detecting wireless local area network (WLAN) transmission signals for use in communication systems incorporating a WLAN radio and a secondary lower power receiver, said method comprising the steps of:
de-activating said WLAN radio;
activating and tuning said secondary receiver to a WLAN transmit frequency;
detecting received signal energy at said WLAN transmit frequency on said secondary receiver;
activating said WLAN radio and receiving a WLAN packet header in response to detecting signal energy at said WLAN transmit frequency over said secondary receiver; and
receiving the remainder of said packet over said WLAN radio if a valid WLAN signal is detected.

2. The method according to claim 1, wherein said step of detecting received signal energy comprises the step of performing spectral matching.

3. The method according to claim 1, wherein said step of detecting received signal energy comprises the step of sampling a plurality of frequencies to detect an envelope of said WLAN transmission.

4. The method according to claim 1, wherein said step of detecting received signal energy comprises the step of accumulating signal energy over the bandwidth of said secondary receiver and comparing said accumulated energy against a predetermined threshold.

5. The method according to claim 1, wherein said secondary receiver is tuned to provide a minimum level of misdetections.

6. The method according to claim 1, wherein said secondary receiver is adapted to detect a predetermined type of preamble in accordance with one or more system parameters.

7. The method according to claim 1, wherein said secondary receiver comprises a Bluetooth capable receiver.

8. A method of detecting wireless local area network (WLAN) transmission signals for use in communication systems incorporating a WLAN radio and a secondary receiver, said method comprising the steps of:
utilizing said secondary receiver as a WLAN preamble detector wherein said secondary receiver is configured to detect WLAN transmit energy; and
activating said WLAN radio if a WLAN signal is detected.

9. The method according to claim 8, wherein said secondary receiver consumes less power than said WLAN radio.

10. The method according to claim 8, wherein said WLAN radio is activated if the frequency envelope of said WLAN transmission is detected.

11. The method according to claim 8, wherein said step of utilizing comprises the step of deactivating said WLAN radio while said secondary receiver is used as a WLAN preamble detector.

12. The method according to claim 8, wherein said step of utilizing comprises the step of performing spectral matching on the signal received by said secondary receiver.

13. The method according to claim 8, wherein said step of utilizing comprises the step of sampling a plurality of frequencies of the signal received by said secondary receiver to detect an envelope of said WLAN transmission.

14. The method according to claim 8, wherein said step of utilizing comprises the step of accumulating signal energy received by said secondary receiver over the bandwidth of said secondary receiver and comparing said accumulated energy against a predetermined threshold.

15. The method according to claim 8, wherein said secondary receiver is tuned to provide a minimum level of misdetections.

16. The method according to claim 8, wherein said secondary receiver is adapted to detect a predetermined type of preamble in accordance with one or more system parameters.

17. The method according to claim 8, wherein said secondary receiver comprises a Bluetooth capable receiver.

18. An apparatus for detecting wireless local area network (WLAN) transmission signals, comprising:
a WLAN radio;
a secondary receiver;
signal detection means coupled to said WLAN radio and said secondary receiver, said signal detection means operative to:
utilize said secondary receiver as a WLAN preamble detector wherein said secondary receiver is configured to detect WLAN transmit energy; and
activate said WLAN radio and switch reception to said WLAN radio if signals received by said secondary receiver indicate reception of a suspected WLAN packet.

19. The apparatus according to claim 18, wherein said secondary receiver is operative to generate an indication when the level of energy detected by said secondary receiver exceeds a predetermined threshold.

20. The apparatus according to claim 18, wherein said secondary receiver consumes less power than said WLAN radio.

21. The apparatus according to claim 18, wherein said WLAN radio is activated if the frequency envelope of said WLAN transmission is detected.

22. The apparatus according to claim 18, wherein said signal detection means comprises means for deactivating said WLAN radio while said secondary receiver is used as a WLAN preamble detector.

23. The apparatus according to claim 18, wherein said signal detection means comprises means for performing spectral matching on the signal received by said secondary receiver.

24. The apparatus according to claim 18, wherein said signal detection means comprises means for sampling a plurality of frequencies of the signal received by said secondary receiver to detect an envelope of said WLAN transmission.

25. The apparatus according to claim 18, wherein said signal detection means comprises means for accumulating signal energy received by said secondary receiver over the bandwidth of said secondary receiver and comparing said accumulated energy against a predetermined threshold.

26. The apparatus according to claim 18, wherein said secondary receiver is tuned to provide a minimum level of misdetections.

27. The apparatus according to claim 18, wherein said secondary receiver is adapted to detect a predetermined type of preamble in accordance with one or more system parameters.

28. The apparatus according to claim 18, wherein said secondary receiver comprises a Bluetooth capable receiver.

29. A mobile communications device, comprising:
a cellular radio;
a WLAN radio;
a secondary receiver;
a processor coupled to said WLAN radio, said secondary receiver and said cellular radio, said processor operative to:
utilize said secondary receiver as a WLAN preamble detector wherein said secondary receiver is configured to detect WLAN transmit energy; and
activate said WLAN radio and switch reception to said WLAN radio if signals received by said secondary receiver indicate reception of a suspected WLAN packet.

30. The mobile communications device according to claim 29, wherein said secondary receiver comprises a Bluetooth capable receiver.
